(19) United States
(12) Patent Application Publication
(10) Pub. No.: US 2004/0085336 A1
(43) Pub. Date: May 6, 2004

(54) System and method for video control in a computer

(75) Inventor: Myoung-Ho Kim, Hwasung-Kun (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon City (KR)

(21) Appl. No.: 10/674,399

(22) Filed: Oct. 1, 2003

(30) Foreign Application Priority Data
Nov. 6, 2002 (KR) 2002-68482

(51) Int. Cl. G09G 5/00

(52) U.S. Cl. 345/716

(57) ABSTRACT

A method of controlling a video control system in a computer having a video controller supplying a picture signal to a displaying apparatus, by setting up in advance a display adjusting value for adjusting a displaying status of a picture displayed on the displaying apparatus, selecting a conversion of the displaying status according to a user's selection, and adjusting the picture signal to be supplied to the displaying apparatus, according to the display adjusting value set up in advance. The adjusted picture signal according to the set up display adjusting value is output to the displaying apparatus via the video controller.

### CROSS-REFERENCE TO RELATED APPLICATIONS

This application claims the benefit of Korean Patent Application No. 2002-68482, filed Nov. 6, 2002, in the Korean Intellectual Property Office, the disclosure of which is incorporated herein by reference.

### BACKGROUND OF THE INVENTION

1. Field of the Invention

The present invention relates, in general, to a system and a method for video control in a computer, and more particularly, to system and a method for video control in a computer wherein display settings according to a use mode of the computer can be easily changed.

2. Description of the Related Art

Currently, the capability of a computer has been enhanced with additional functions of processing multimedia data, such as pictures and sounds, whereby the computer reproduces multimedia data supplied by a CD-Rom and a TV card, or through the Internet, and supplies a user of the computer with a variety of moving pictures. Moreover, as a variety of games using the computer have been introduced in line with popularization of on-line games, the kind of multimedia-based moving pictures supplied through the computer has increasingly become varied.

When a moving picture or a game picture is displayed through the computer, the quality of moving pictures can be improved by changing the display settings, such as brightness, contrast, gamma value and sharpness, etc., of the picture. The display settings can be changed by an OSD (On Screen Display) application provided in a monitor. In particular, if a user desires to change the display settings, the user activates an OSD menu on the monitor by an OSD key provided in the monitor and selects any setting value from the displayed menu to thereby change the display settings of the monitor. However, when changing the display settings by the OSD, a brightness value, a contrast value, and so on, respectively need to be increased or otherwise decreased to set an adequate displaying status of the picture, thereby causing the user to feel inconvenient. In addition, whenever the use mode of the computer is changed from a word-processing mode for drafting a text to a moving pictures-reproducing mode, the display settings should be changed, thereby causing the user to have a trouble in using the computer.

To solve these problems as mentioned above, software for adjusting the displaying status of a picture on the monitor has been developed. If the picture displayed on the monitor is adjusted by using the software, the computer supplies the monitor with control data for changing the display settings as the user has input as though such control data is input via the OSD. It is possible to change the display settings by allowing the monitor to change the inherent (i.e., previously set, default, etc.) settings according to the control data for changing the display settings supplied from the computer. However, if the monitor does not support a function of receiving control data from the computer to change the display settings according to the received control data, it is not possible to change the display settings by using the software.

### SUMMARY OF THE INVENTION

Accordingly, the present invention provides a system and a method for video control in a computer, facilitating change of the display settings in response to a use mode of the computer.

Additional aspects and advantages of the invention will be set forth in part in the description which follows and, in part, will be obvious form the description, or may be learned by practice of the invention.

The present invention may be achieved by providing a method of controlling a video control system in a computer having a video controller supplying a picture signal to a displaying apparatus, comprising setting up in advance a display adjusting value for adjusting a displaying status of a picture displayed on the displaying apparatus; selecting a conversion of the displaying status according to a user's selection; adjusting the picture signal to be supplied to the displaying apparatus, according to the display adjusting value set up in advance; and outputting the picture signal adjusted according to the display adjusting value to the displaying apparatus from the video controller.

According to an aspect of the present invention, the setting up of the display adjusting value in advance comprises setting upon a value for adjusting any one of brightness, color, contrast and gamma of a moving picture displayed on the displaying apparatus.

According to an aspect of the present invention, the method further comprises selecting a picture conversion automatic execution function to allow the displaying status of the picture to be automatically converted upon displaying a moving picture on the displaying apparatus. In particular, the method comprises ascertaining whether the moving picture is displayed on the displaying apparatus; adjusting a signal of the moving picture supplied to the displaying apparatus according to the display adjusting value set up in advance, if ascertained that the moving picture is displayed on the displaying apparatus; and allowing the adjusted moving picture signal to be displayed on the displaying apparatus from the video controller.

The present invention may be also achieved by a method of controlling a video control system in a computer having a video controller supplying a picture signal to a displaying apparatus and a video driver controlling the video controller, comprising setting up in advance, at an application level of an operating system, a display adjusting value for adjusting a displaying status of a picture to be displayed on the displaying apparatus; hooking a signal input by the user, to be transmitted to the operating system; ascertaining whether the input signal is a signal for selecting a conversion of the displaying status of the picture; supplying the display adjusting value set up in advance to the video driver, if the conversion of the picture displaying status is selected; adjusting the picture signal to be supplied to the displaying apparatus based on the display adjusting value set up in advance, according to a control of the video driver; and allowing the picture signal adjusted according to the pre-set display adjusting value to be output to the displaying apparatus from the video controller.

The present invention may be also achieved by providing a system for video control in a computer having a video controller supplying a picture signal to a displaying apparatus, comprising a display adjusting part adjusting a displaying status of a picture displayed on the displaying apparatus; a picture adjusting value storing part storing therein a display adjusting value input through the display adjusting part; a displaying status conversion part selecting a conversion of the displaying status of the picture displayed on the displaying apparatus; a controller controlling the video controller to allow the display adjusting value input through the display adjusting part to be stored in the display adjusting value storing part and setting a value of the picture signal output from the video controller to be changed based on the display adjusting value stored in the display adjusting value storing part in response to the selection of the displaying status conversion through the displaying status conversion part.

According to an aspect of the present invention, the display adjusting value for displaying a moving picture input through the display adjusting part is stored in the display adjusting value storing part; and the controller controls the video controller to allow the setting values of a signal of the moving picture output from the video controller to be changed according to the display adjusting value stored in the display adjusting value storing part as a user selects the displaying status conversion through the displaying status conversion part.

According to an aspect of the present invention, the system further comprises an automatic execution selector for picture conversion, automatically converting the displaying status, if a moving picture is displayed on the displaying apparatus, wherein if the automatic conversion of the displaying status is selected through the automatic execution part, the controller controls the video controller to allow the setting values of a signal of the moving picture output from the video controller to be changed in response to the display adjusting value stored in the display adjusting value storing part, upon sensing that the moving picture is displayed on the displaying apparatus.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of hardware components of a video control system for a computer, according to an embodiment of the present invention;

FIG. 2 is a control block diagram of software components of the video control system for the computer shown in FIG. 1, according to an embodiment of the present invention; and

FIG. 3 is a flow chart of controlling display settings of the video control system in the computer as shown in FIG. 2, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

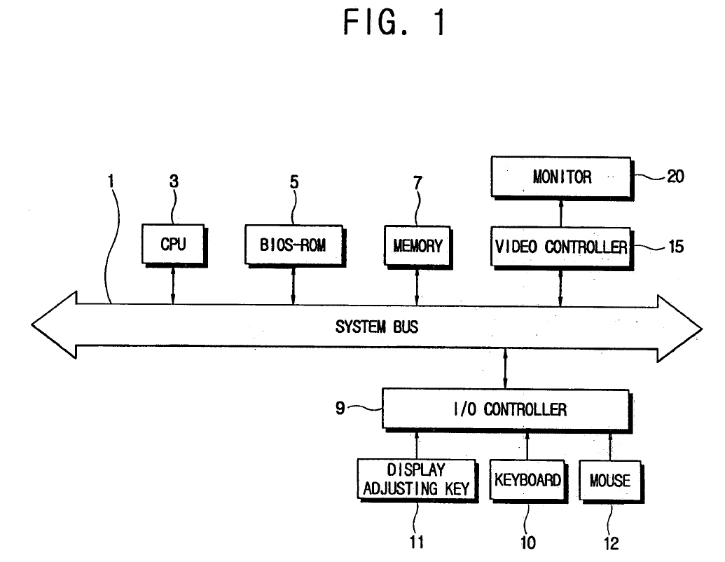

FIG. 1 is a control block diagram of hardware components of a video control system for a computer, according to an embodiment of the present invention. As shown therein, a video control system for a computer comprises a central processing unit (CPU) 3, a memory 7, a BIOS-ROM storing therein the BIOS (basic input/output system), a system bus 1, a video controller 15 supplying picture signals to a monitor 20, and an I/O controller controlling/interfacing a keyboard 10, a mouse 12, and a display adjusting key 11.

The display adjusting key 11 allows a user to change display settings of the monitor according to a use mode of the computer, and, typically, the display adjusting key 11 is provided as a separate key on a keyboard or on the computer body. Otherwise, the display adjusting key 11 may be replaced with special input keys on the keyboard 10 as combined (e.g., ctrl+F1, ctrl+F2, etc.). Because the use mode for which the display settings of the monitor are to be changed may be plural, there may be plural display adjusting keys 11, such as a moving picture adjusting key, a game picture adjusting key, a word-processing display adjusting key, and so on.

The I/O controller 9 processes a signal input from the display adjusting key 11, the keyboard 10 or the mouse 12 and converts the input signal into a signal compatible with the computer system, and the CPU 3 performs an operation based on the input signal and controls the components of the computer system.

The video controller 15 produces data for displaying a picture on the monitor 20, according to data supplied through the system bus 1, by supplying the displayable data to the monitor 20, thereby allowing the data processed in the computer system to be displayed on the monitor 20.

Meanwhile, the CPU 3 supplies a control signal to the video controller 15 according to the signal input to change the settings of a picture displayed on the monitor 20 (i.e., to change the monitor 20 display settings) through the display adjusting key 11. In particular, the settings of the picture signal supplied to the monitor 20 can be changed according to the display adjustment value(s) as set up in advance. Because the picture signal itself supplied to the monitor 20 from the video controller 15 is adjusted and the adjusted picture signal is supplied to the monitor 20, a picture can be displayed according to the pre-set display adjustment value the user has input.

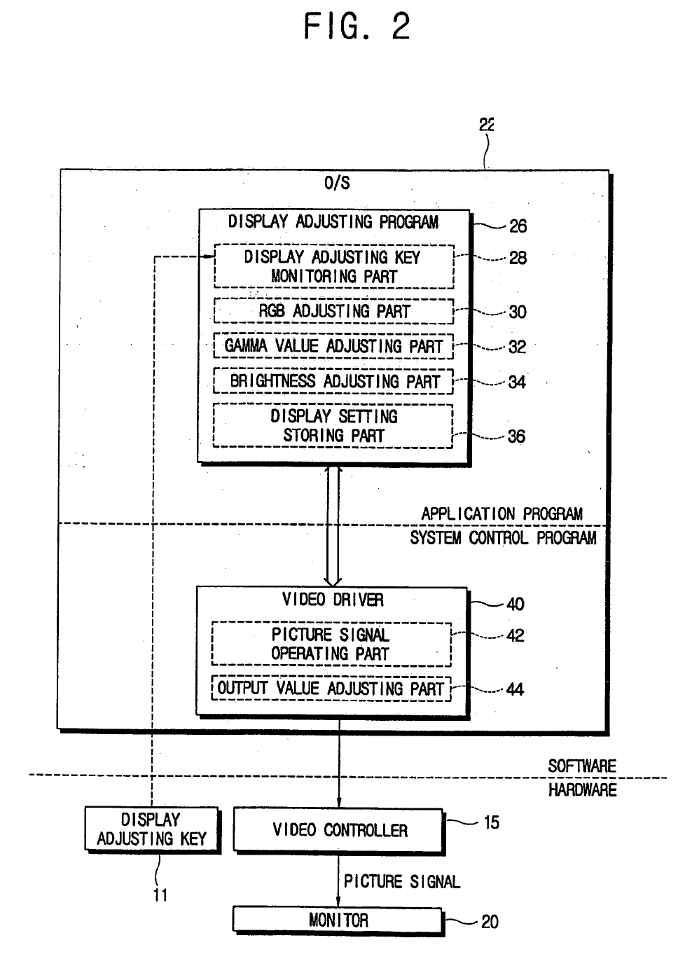

FIG. 2 is a control block diagram of software components of the video control system for the computer as shown in FIG. 1, according to an embodiment of the present invention. In FIG. 2, the software video control system for the computer comprises a video driver 40 controlling the video controller 15 as a hardware unit of the video control system for the computer, and a program 26 for display adjustment as a high-level application software (application program) controlling the video driver 40. The video driver 40 is software controlling the video controller 15, the video driver 40 as a program being in a logical combination with the video controller 15 as a hardware unit. The video driver 40 initializes the video controller 15 or controls the video controller 15 to adjust the setting value of the picture signal supplied to the monitor 20.

The video driver 40 typically comprises a picture signal operating part (display signal processor/adjuster) 42 and an output value adjusting part 44, and so on, which change the settings of the output picture to the video controller 15 according to an input or preset display adjusting value. With respect to a displayed picture divided into an on screen space and an off screen space (i.e., a still displayed image), typically, the picture signal operating part 42 changes the displayed picture by performing an ‘AND’ operation on data stored beforehand in an off screen memory and a mask table representing a display adjusting value and multiplying the result by the gain value of the picture signal. In addition, if a moving picture signal is displayed, the picture signal operating part 42 can change the picture signal output for displaying the moving picture by performing an ‘AND’ operation on the moving picture data stored in a frame buffer and the picture signal gain value. As described above, the video driver 40 can change the display settings of a picture displayed on the monitor 20 by controlling the video controller 15 to output a changed picture signal to the monitor 20. In particular, typically, the output value adjusting part 44 changes the picture signal output to the video controller 15 and controls the video controller 15 to output the picture signal having the changed output value to the monitor 20.

The display adjusting program 26 is an application software executing based on an operating system 22 and supplying the display adjusting value input by the user, for example, via the display adjusting key 11, to the video driver 40 so that the video driver 40 can control the video controller 15 to change the display settings for the picture signal supplied to the monitor 20. The display adjusting program 26 adjusts display settings according to a user input, or a predetermined, display use mode (display job) setting, and, typically, comprises a display adjusting key monitoring part 28 monitoring a display adjusting key, an RGB adjusting part 30 adjusting any available/allowable display settings, such as color, etc., input by the user or as preset, a gamma value adjusting part 32, a brightness adjusting part 34, and a display setting storing part 36 storing therein the changed display adjusting value. The present invention as embodied in the display adjusting program 26 controlling a video controller output to a monitor according to set display adjustment settings of an application processing by the computer system (i.e., a display setting relative to a job environment in execution), which comprises (without limitation) the display adjusting key monitor 28, the RGB adjustor 30, the GAMMA value adjustor 32, the brightness adjustor 34, and the display setting storing part 36, are implemented in software and/or computing hardware.

The display adjusting key monitoring part 28 hooks the input'signal through such input units as the mouse 12, the keyboard 10 or the display adjusting key 11, etc., while the operating system 22 is executing, and determines, for example, whether the input signal is input from the display adjusting key 11. Thus, the user can adjust the picture displayed on the monitor anytime while the display adjusting program 26 is being executed. The user can change the display settings for brightness, color, etc., of the displayed picture by the RGB adjusting part 30, the gamma value adjusting part 32, and the brightness adjusting part 34. Since the display adjusting value of the picture input through each adjusting part by the user is supplied to the video driver 40 through the display adjusting program 26, the display adjusting value changed by the user can be reflected in the picture signal output to the monitor 20.

The display adjusting program 26 further comprises an automatic execution selector (not shown) by which an automatic execution of the display adjusting function can be selected. Typically, the automatic execution selector allows selecting either automatic execution of the display adjusting function to automatically change the display setting according to a use mode of the computer, or manual execution of the display adjusting function by a user input via the display adjusting key 11 to change the display setting according to a use mode of the computer. Typically, the above-described adjusting parts 30, 32 and 34 are implemented as displayed menu windows, thereby promoting the user's convenience.

With the present invention configuration, a displaying status corresponding to a variety of computer use modes can be setup through the display adjusting program 26, which is an application at the level of the operating system 22, and set up display adjusting data can be transmitted to the video driver 40 to accordingly control the video controller 15. The video driver 40 controls the video controller according to the display adjusting data to change the color, brightness, gamma, etc., of the picture signal output to the monitor 20, thereby allowing the display adjusting value input by the user to be reflected in the displayed picture.

According to the present invention, the display settings can be changed by executing the display adjusting function in the display adjusting program 26 and changing the display settings of the picture signal output to the monitor 20 from the video controller 15. That is, because the monitor 20 merely performs a function of displaying the picture signal as changed, the display setting changing function can be applied, regardless of the capability of the monitor 20. Accordingly, the display settings of a monitor that cannot process control data from the computer main body can be adjusted via an application, software at the computer main body by adjusting display signals input to the monitor. In addition, because the display settings can be adjusted through the application software at the level of the operating system 22, it is easy to change the display settings. For example, the method of adjusting the display settings can be flexible as programmed.

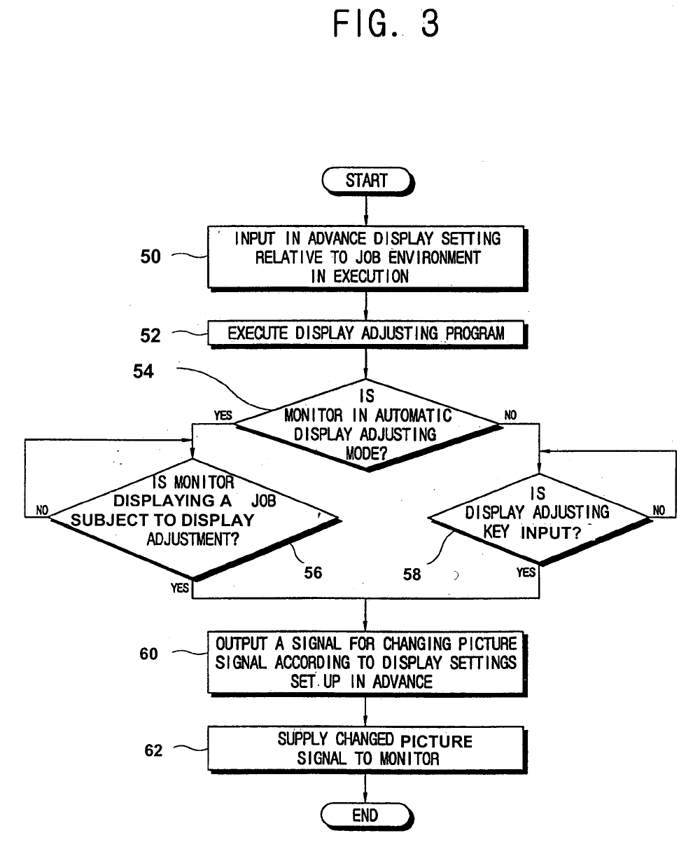

FIG. 3 is a flow chart of controlling display settings of the video control system in the computer as shown in FIG. 2, according to an embodiment of the present invention. To change the display settings according to a conversion of a use mode of a computer (i.e., relative to an executing job, or a job status, in the computer), at operation 50, the user inputs display adjusting values for the respective use modes in advance, by using the display adjusting program 26. For example, at operation 10, the user can adjust a displaying status, such as brightness, color, gamma value, etc., of the picture (displayed image on the monitor 20) through the RGB adjusting part 30, the gamma value adjusting part 32, the brightness adjusting part 34, etc., of the display adjusting program 26, according to the display adjusting values input for the respective use modes and stored in the display setting storing part 36. At this time, typically, the user is allowed to select whether to set the display settings to be automatically converted in response to the conversion of the use mode, or whether to set the display settings to be converted upon user input.

At operation 52, the display adjusting program 26 is executed, which is after completion of the setting up of the display adjusting values in operation 50 as described above, and, at operation 54, the display adjusting program 26 ascertains whether the system is in the automatic display adjusting mode. If determined at operation 54 that the system is in the automatic display adjusting mode, at operation 56, the display adjusting program 26 ascertains whether a current use mode of the computer requires display adjustment (i.e., whether the monitor is processing/displaying a job output subject to displaying adjustment). For example, if the user has a set up so that the display settings are converted (adjusted) if the monitor displays a moving picture, or a game picture, etc., the display adjusting program 26 can be supplied with or retrieve data concerning a kind of a job currently in execution by the monitor 20 from the operating system 22.

If determined at operation 56 that the moving picture or the game picture is currently displayed after ascertaining the job environment, at operation 60, the display adjusting program 26 supplies the display adjusting value corresponding to the current job status to the video driver 40. At operation 62, the video driver 40 controls the video controller 15 according to the display adjusting value, which is supplied by the display adjusting program 26, to supply an adjusted picture signal to the monitor 20. Accordingly, if the automatic display adjusting mode is set up, the picture whose display settings, such as brightness, and so on, are automatically changed (adjusted) is displayed on the monitor 20, with the brightness, color, etc., of the picture signal output from the video controller 15 as adjusted according to the display settings input in advance by the user.

If determined at operation 54 that the system is not in the automatic display adjusting mode, at operation 58, the display adjusting program 26 ascertains whether the display adjusting key 11 is input. If determined at operation 28 that the display adjusting key 11 is selected, the display adjusting program 26 supplies the set up display adjusting value corresponding to a selection of the display adjusting key 11 to the video driver 40. At operation 62, the video driver 40 controls the video controller 15 according to the display adjusting value supplied by the display adjusting program 26, thereby allowing an adjusted picture signal to be supplied to the monitor 20. Therefore, the picture displayed on the monitor 20 can be converted into a picture with appropriate brightness, color, etc., for the job currently in execution, as the user selects the display adjusting key 11 corresponding to the current job.

As described above, according to the present invention, the display settings of the picture signal, such as brightness, color, contrast, gamma, sharpness, position/size, tilt, etc., (i.e., any available and/or allowable display adjustment), are changed according to the user's selection and supplied to the monitor, and thus, the most agreeable picture can be displayed regardless of monitor display setting adjustment capability. In addition, because the display adjusting values-relative to the respective use modes of the computer are stored in advance, the display settings of the monitor can be changed appropriately according to a current use mode when the user selects the display adjusting key or the computer is in the automatic display adjusting mode, thereby facilitating the display adjustment according to each use mode. According to the present invention, a computer allows changing the display settings according to a use mode of the computer. In particular, the present invention provides a computer video control system allowing a display adjusting value input adjusting a displaying status of a picture displayed on a computer monitor, allowing the displaying status conversion selection, and changing a picture signal output to the monitor in response to the displaying status conversion selection and based on the input display adjusting value. Therefore, the present invention provides a computer system controlling, automatically or manually via user input, a video controller output to a monitor according to set display adjustment settings of an application processing, such as word processing, video reproduction, game image reproduction, etc., by the computer system.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling a video control system in a computer having a video controller supplying a picture signal to a displaying apparatus, comprising:
setting up in advance a display adjusting value for adjusting a displaying status of a picture displayed on the displaying apparatus;
selecting a conversion of the displaying status according to a user selection;
adjusting a signal of the picture to be supplied from the video controller to the displaying apparatus, according to the user selection and the display adjusting value set up in advance; and
outputting the picture signal adjusted according to the display adjusting value to the displaying apparatus from the video controller.

2. The method according to claim 1, wherein the setting up of the display adjusting value in advance comprises setting a value for adjusting any one of brightness, color, contrast, and gamma of a moving picture displayed on the displaying apparatus.

3. The method according to claim 2, further comprising:
selecting a picture conversion automatic execution function to allow the displaying status of the picture to be automatically converted if the moving picture is displayed on the displaying apparatus;
ascertaining whether the moving picture is displayed on the displaying apparatus;
adjusting the signal of the moving picture supplied from the video controller to the displaying apparatus according to the display adjusting value set up in advance, if ascertained that the moving picture is displayed on the displaying apparatus; and
allowing the moving picture adjusted according to the display adjusting value to be displayed on the displaying apparatus from the video controller.

4. A method of controlling a video control system in a computer having a video controller supplying a picture signal to a displaying apparatus and a video driver controlling the video controller, comprising:
setting up in advance, at an application level of the computer operating system, a display adjusting value for adjusting a displaying status of a picture to be displayed on the displaying apparatus;
hooking a user input signal transmitted to the operating system;
ascertaining whether the input signal is selecting a conversion of the displaying status of the picture;
supplying the display adjusting value set up in advance to the video driver, if the conversion of the picture displaying status is selected;
adjusting in the video driver the picture signal to be supplied to the video controller based on the supplied display adjusting value; and
outputting the adjusted picture signal to the displaying apparatus from the video controller.

5. A system for video control in a computer having a video controller supplying a picture signal to a displaying apparatus, comprising:
a display adjusting input part allowing input of a display adjusting value adjusting a displaying status of a picture displayed on the displaying apparatus;
a picture adjusting value storage storing the input display adjusting value;
a displaying status conversion part selecting a conversion of the displaying status of the picture displayed on the displaying apparatus according to a user selection;
a controller controlling the video controller and changing a picture signal to be output from the video controller based on the stored display adjusting value, in response to the selected displaying status conversion.

6. The system according to claim 5, wherein the input display adjusting value is for displaying a moving picture; and
the controller changes the picture signal to be output from the video controller according to the stored moving picture display adjusting value.

7. The system according to claim 5, further comprising an automatic execution selector automatically converting the displaying status if a moving picture is displayed on the displaying apparatus;
wherein the controller changes the moving picture signal to be output from the video controller according to the stored display adjusting value, if sensed that the moving picture is displayed on the displaying apparatus.

8. A computer video control system, comprising:
a programmed computer processor storing a display adjusting value to convert a displaying status of a picture displayed on a monitor, selecting a displaying status according to a job processing, and changing a picture signal output to the monitor in response to the displaying status selection and based on the stored display adjusting value.

9. A computer system, comprising:
a programmed computer processor controlling a video controller output to a monitor according to set display adjustment settings of an application processing by the computer system.

10. The computer system of claim 9, wherein the display adjustment settings comprise at least one of brightness, contrast, color, gamma, sharpness, position/size, and tilt.

11. A computer system, comprising:
a video controller outputting an image signal to a displaying apparatus; and
a machine-readable storage storing at least one program controlling the computer system according to a process comprising:
setting up in advance a display adjusting value adjusting a displaying status of the image displayed on the displaying apparatus;
selecting an adjustment of the displaying status according to a user selection;
adjusting the image signal according to the user selection and the display adjusting value set up in advance; and
outputting the adjusted image signal to the video controller to be output to the displaying apparatus.

12. The computer system of claim 11, wherein the image signal adjusting comprises performing an ‘AND’ operation on data stored in a display memory and a mask table representing the display adjusting value, and multiplying a result of the ‘AND’ operation by a gain value of the image signal.

13. The computer system of claim 11, wherein the image is a moving image and the image signal adjusting comprises performing an ‘AND’ operation on data stored in a frame buffer of the moving image signal and a gain value of the image signal.
